(19) United States
(12) Patent Application Publication
(10) Pub. No.: US 2013/0132177 A1
(43) Pub. Date: May 23, 2013

(54) SYSTEM AND METHOD FOR PROVIDING SHARING REWARDS

(71) Applicant: Vincent Ha, Singapore (SG)

(72) Inventor: Vincent Ha, Singapore (SG)

(21) Appl. No.: 13/302,203

(22) Filed: Nov. 22, 2011

(51) Int. Cl. G06Q 30/02

(52) U.S. Cl. 705/14.19

(57) ABSTRACT

The present invention generally relates to social networking rewards. Specifically, this invention relates to a system and method for providing rewards to users of one or more social networks for performing certain specified tasks.

### FIELD OF THE INVENTION

The present invention generally relates to social networking rewards. Specifically, this invention relates to a system and method for providing rewards to users of one or more social networks for performing certain specified tasks.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The world of social networking has grown into a vast and complicated web of mainstream and niche platforms dedicated to providing connections between a plurality of users. One of the most commonplace functionalities of these social networking platforms is the ability to connect with friends, family members, co-workers or people with similar interest in order to allow open communication and sharing amongst such connections.

While these social networking sites frequently allow users to “like,” “friend”, “follow,” “comment” or otherwise take some action in relation to the content or accounts of others, in order to get another user to take one of these actions on the account or content of a first user, these social networking sites are limited to submitting requests to do so (e.g., request to add a friend, request to like a page, request to like some content).

Even though a user's social network may be comprised of friends and family or others who would generally assist the user, it is frequently difficult to inspire others to take some desired action in relation to the user's content. This is especially the case as social networks become more ubiquitous and the total number of requests becomes large. In this case, requests become noise and many are lost in a forest of other requests.

Additionally, users face problems when going through existing social media advertising channels or paid engagement channels in order to spread their message. For instance, when buying ads, current systems provide some limited ability to setup targeting factors and budget, but provide no knowledge over the identities of the recipients of the advertising message. This is typically because certain information is only privy to social network owners. Disadvantageously, the cost is the same whether the message is shown to a highly influential person or a low influence individual. Current systems provide no way to incentivize action of a target audience beyond the messaging of the advertisement (e.g., click on this to win!).

Currently, spreading messages to social media users through an agency, or platform reacts no differently than from social media advertising where the message, target audience and budget is committed to the agency/platform and the brand has no knowledge of the audience beyond demographic profiles. In this manner, utilization of agencies does not create a true brand-to-fan connector. While some systems in the prior art utilize polls and insights as well as gamification, these alone are not an effective tool for social media engagement. Additionally, agencies use a black box model. Money, message and demographic information goes in, reports on results comes out.

Advertising on individual social networks involves targeting individual profiles on those networks and is not capable of directly reaching the same individual who may have multiple profiles on multiple networks (e.g. Twitter and Facebook). Information contained within each social network does not factor information that maybe present (and valuable to companies) on other social networks. Thus there is wasted effort in reaching the same demographic across different social networks.

Additionally, present social media advertising platforms are built for businesses. Individuals and hobbyists may have marketing needs that are inadequately met by the current platforms. Currently alternatives include online classifieds, ebay, etc which maybe ill-suited to execute social media marketing campaigns on behalf of individuals. Certain social media advertising tools levy minimum budget requirements as well as charge high fees, increasing barriers for a common user. Therefore, the consumer does not benefit directly from advertising

Therefore, there is a need in the art for a system and method for providing a way to inspire users of a social network to take specific actions in relation to content provided on one or more social networks through the use of rewards or incentives.

These and other features and advantages of the present invention will be explained and will become obvious to one skilled in the art through the summary of the invention, drawings, brief description of the drawings and detailed description that follows.

### SUMMARY OF THE INVENTION

Accordingly, the present invention provides a platform for providing users with the ability to create, generate and share one or more rewards with other users of any number of connected social networking platforms. The platform of the present invention provides systems and methods for providing allowing a user to create and apply one or more incentives or rewards to users of one or more social networks based on actions taken by the users of one or more social networks.

According to embodiments of the present invention, the system may be configured to allow a user to identify a desired task to be performed, designate one or more desired rewards or incentives including parameters associated with said desired rewards or incentives and transmit said desired task offering to one or more other users.

According to an embodiment of the present invention, rewards and incentives may include cash compensation, credits, virtual goods, badges, tickets or any other virtual or physical compensation.

According to embodiments of the present invention, desired tasks may include “liking” a page, sending specified content, reposting specified content, taking a questionnaire, rating specified content or otherwise providing social network content to others.

According to embodiments of the present invention, the system may be configured to allow a user to be a company. In this manner, companies may engage other users who are companies or individuals in order to allow those users to register with the company in order to provide social media activities on behalf of the companies. The company may provide one or more rewards or incentives based on the type of user and amount of social actions the user performs on behalf of the company.

According to embodiments of the present invention, the system may be configured to allow users to provide reward or incentive programs across multiple social networking platforms. For instance, the system may be configured to provide a single reward and incentive program across social networking platforms such as Facebook®, Twitter® and LinkedIn®. The user may be provided the functionality to determine rewards or incentives evenly across the various platforms or provide different rewards or incentives based on which platform is used.

According to embodiments of the present invention, the system may be configured to allow targeting of demographic information aggregated from various social networks (e.g., number of friends, number of followers, quality of first degree connections). The system may also be configured to factor in a method for ranking and establishing a score for influence across social media networks, known as a social media influence score. Social media influence scoring allows more robust targeting beyond simple demographic information to allow companies to find influential individuals with little effort.

According to embodiments of the present invention, the system may also be configured to allow payment according to the extent of social influence (e.g., score of 0 gets $1, score of 100 gets $100, linear or exponential proportioning).

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic overview of a network system for carrying out this invention in accordance with an embodiment of the present invention;

FIG. 2 is an exemplary process for generating a content incentivizing campaign, in accordance with an embodiment of the present invention;

FIG. 3 is an exemplary process for interacting with a content incentivizing campaign, in accordance with an embodiment of the present invention;

FIG. 4 is a schematic overview of a network system for aggregating information across social networks in accordance with an embodiment of the present invention;

FIG. 5 is a view of a dashboard of a content incentivizing platform in accordance with an embodiment of the present invention; and

FIG. 6 is a view of a wizard screen in accordance with an embodiment of the present invention.

### DETAILED SPECIFICATION

The present invention generally relates to social networking rewards. Specifically, this invention relates to a system and method for providing rewards to users of one or more social networks for performing certain specified tasks.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

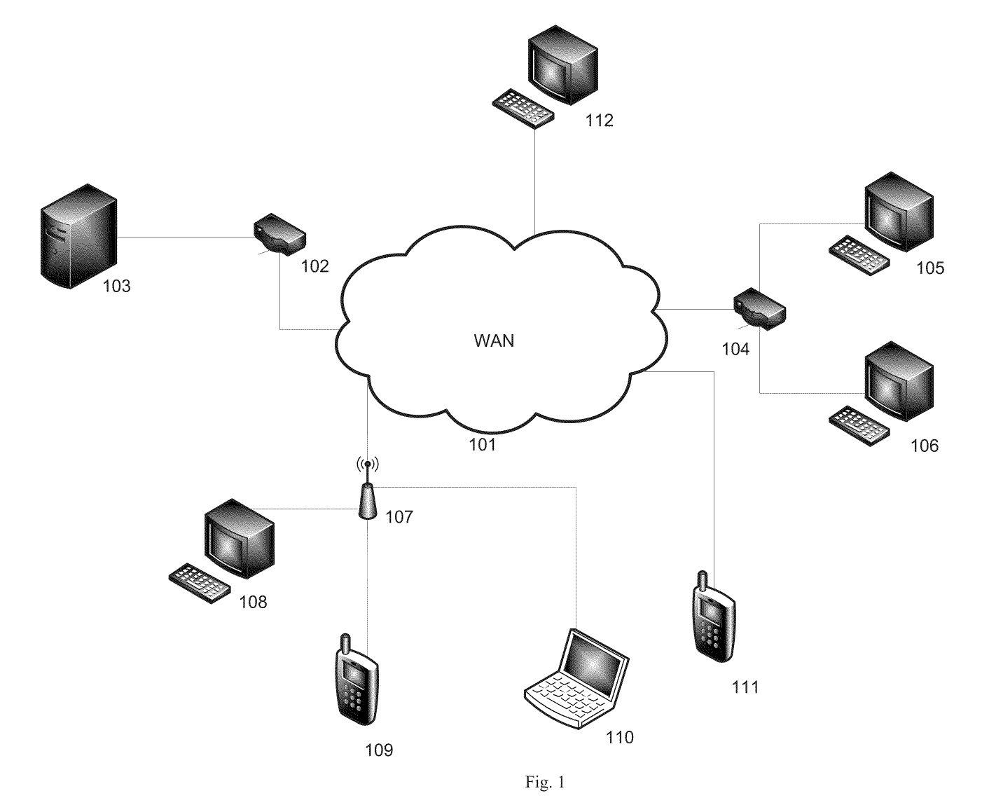

Referring to FIG. 1, a schematic overview of a system in accordance with an embodiment of the present invention is shown. The system is comprised of one or more application servers 103 for electronically storing information used by the system. Applications in the server 103 may retrieve and manipulate information in storage devices and exchange information through a WAN 101 (e.g., the Internet). Applications in server 103 may also be used to manipulate information stored remotely and process and analyze data stored remotely across a WAN 101 (e.g., the Internet).

According to an exemplary embodiment, as shown in FIG. 1, exchange of information through the WAN 101 or other network may occur through one or more high speed connections directed through one or more routers 102. Router(s) 102 are completely optional and other embodiments in accordance with the present invention may or may not utilize one or more routers 102. One of ordinary skill in the art would appreciate that there are numerous ways server 103 may connect to WAN 101 for the exchange of information, and embodiments of the present invention are contemplated for use with any method for connecting to networks for the purpose of exchanging information.

Members may connect to server 103 via WAN 101 or other network in numerous ways. For instance, a Member may connect to the system i) through a computing device 112 directly connected to the WAN 101, ii) through a computing device 105, 106 connected to the WAN 101 through a routing device 104, iii) through a computing device 108, 109, 110 connected to a wireless access point 107 or iv) through a computing device 111 via a wireless connection (e.g., CDMA, GMS, 3G, 4G) to the WAN 101. One of ordinary skill in the art would appreciate that there are numerous ways that a member may connect to Server 103 via WAN 101 or other network, and embodiments of the present invention are contemplated for use with any method for connecting to Server 103 via WAN 101 or other network.

Social Action Campaigns

According to an embodiment of the present invention, the system is configured to allow a user to develop a campaign for sharing rewards or incentives via one or more social networking platforms. In an exemplary embodiment, the system would be configured to provide the user with a one or more webpages that allows the user to design and implement the campaign via a graphical user interface, providing the user a set of options to appropriately configure the campaign as desired by the user. One of ordinary skill in the art would appreciate that the term user could refer to an individual, corporation, partnership or any other entity.

Since users have a multitude of privacy options, including hiding their name, profile picture, specific search tags from an aggregated pool of search tags, embodiments of the system may be configured to target based on only those demographics that are available to it as well as by a social influence score (defined below). Users of social media do not always reveal sensitive information that might be otherwise relevant to advertisers. Revealing information such as income on social media networks maybe considered socially taboo in some cultures. The system allows users to reveal such information through a tagging system. This increases the discoverability of individuals and the relevancy of the user base to the advertising brands. Compensation may also be based, at least in part, on a social influence score of a user. Actions taken by individuals with higher social influence scoring than other users may demand a higher premium for their actions. One of ordinary skill in the art would appreciate that there are numerous ways to value the compensation of a user based on a social influence scoring, and embodiments of the present invention are contemplated for use with any appropriate method of providing compensation based on the strength of a social influence score.

The configuration of a campaign may be comprised of one or more steps as described below. Some of the steps may be skipped in order to provide a streamlined process. In other embodiments, campaigns may be developed from templates, wizards, preferences, information from previously launched or saved campaigns or any combination thereof. One of ordinary skill in the art would appreciate that these steps could be offered in various manners and combinations, all variations are contemplated for use herein.

A first component of designing a campaign is to define the task the user wants to incentivize other users to perform. For instance, a user may want to incentivize other users to upload a photo, tag individuals in wall posts or tweets, liking content pages, posting comments on other user's walls, getting other users to like content pages, getting other users to post comments or tweets related to the user's incentivized content. One of ordinary skill in the art would appreciate that there are numerous tasks a user may incentivize in accordance with embodiments of the present invention, and embodiments of the present invention are contemplated for use with any appropriate task.

Another component of configuring a campaign is to decide what users will have access to the campaign as a potential incentivized user. A user may select the potential incentivized users in numerous manners. For instance, incentivized users may be any user on one or more social networking platform, a specified group of individuals, a group of individuals associated with some characteristic (e.g., female, female over 30 years of age, males 18-25 with interests in video games). One of ordinary skill in the art would appreciate there are numerous ways to categorize individuals and users for use in creating potential groups of incentivized users, and embodiments of the present invention are contemplated for use with any group of incentivized users.

According to an embodiment of the present invention, the system may be configured to allow a user to target specific users in order to incentivize particular users based on a social influence score. A social influence score can be calculated in a variety of ways. For instance, a social influence score may be based, at least in part, on how many friends/followers a user has, how many platforms the user engages his/her friends/followers on and how often he/she interacts with his/her friends/follows. The user may target individuals within a particular range of social influence scoring, such as above a set score, between two or more set scores, below a set score or any combination thereof.

In an exemplary embodiment of the present invention, a creator of a campaign may be provided a wizard to assist in the campaign creation process. Wizards are software driven components that assist in commonly utilized functions. In the present case, the wizard may preload certain common campaign components, allowing the creator to customize and guide the campaign creation process with ease. Wizards may be configured to provide campaign templates, frequently used tasks, tasks that historically have performed well, previously selected groups to incentivize or any combination thereof. One of ordinary skill in the art would appreciate that there are several ways wizards may be utilized in accordance with embodiments of the present invention, and embodiments of the present invention are contemplated for use with wizards of all manners.

In an exemplary embodiment of the present invention, a campaign creator may be provided a list of individuals or groups to incentivize. The campaign creator may then browse and select individuals and/or groups and offer them some incentive for performing the desired tasks. As noted above, the groups and individuals can be sorted or filtered based on one or more demographic and profiling criteria. This information can either be pulled from the one or more social networks being utilized or from information previously provided to the system regarding the individuals or groups.

According to an embodiment of the present invention, a campaign creator may choose whether to make a campaign open to the public or private (i.e., only available to those individuals or groups selected by the campaign creator). In this manner, companies with large consumer bases can allow anyone to access and partake in the campaign, thus helping to build brand loyalty and awareness. In another facet, by limiting the campaign to selected individuals or groups, the campaign can be targeted for a specific purpose. For instance, the campaign could be limited to a group of celebrities that the campaign creator wishes to take one or more tasks to promote the products of a company.

According to an embodiment of the present invention, a campaign creator can request that the system utilize one or more verification services to verify the identity or other characteristics of an individual or group. Verification services can be completely automated, manually provided or some combination thereof. One of ordinary skill in the art would appreciate that there are numerous verification services that could be utilized with embodiments of the present invention, and embodiments of the present invention are contemplated for use with any verification service.

According to an embodiment of the present invention, the system is configured to rank or rate the performance of various campaigns that have concluded or expired. Optionally, campaigns can be ranked during the time the campaign is running. Ranking of a campaign can be done on one or more metrics and can be utilized to help campaign creators see which campaigns worked and which were less successful. Campaigns may be ranked, for instance, on number of participants, number of times a task was completed, how fast the campaign ran its course (i.e., spent all of its budget), how durable the gain way (i.e., did the campaign raise the base level of traffic to a company's page, even after the campaign completed) or any combination thereof. One of ordinary skill in the art would appreciate that there are numerous ways to rank a campaign, and embodiments of the present invention are contemplated for use with any manner of ranking campaigns.

According to an embodiment of the present invention, the system may provide campaign creators or others the ability to escrow funds or other resources to cover payments of other transactions associated with a campaign. In this manner, the system can allow an incentive campaign to run for as long as there are appropriate escrow funds held at or by the system.

According to an embodiment of the present invention, the system is configured to provide a campaign creator, or any other number of users associated with the campaign, the ability to track the progress of a campaign. This may include the number of times the campaign has been viewed or interacted with, how many new users vs. returning users are coming to the campaign, how many qualified users have viewed or interacted with the campaign or any combination thereof. One of ordinary skill in the art would appreciate that there are numerous metrics that could be utilized and displayed to the campaign creator or any other member, and embodiments of the present invention are contemplated for use with any appropriate metrics.

According to an embodiment of the present invention, the system is configured to provide users the ability to create brand badges which are added to one or more users' profile(s) upon completion of a brand's task. This allows brands to continually engage with the same group of consumers, thereby increasing their interactions and influencing them toward sales conversions. The advantage created is that unlike social media advertising that is one-off, having this tracking ability as well as identities of the users enables brands to form genuine connections with their users on social media platforms.

User Interaction

According to an embodiment of the present invention, the system is configured to allow individual users can browse through campaigns and join campaigns that interest them, assuming they are qualified to join a particular campaign. The system may also allow for connected individuals (i.e., those individuals linked via one or more social networking platforms) to communicate amongst themselves via forums, message boards, instant messenger or other communications methods. One of ordinary skill in the art would appreciate that there are numerous ways to provide communications amongst members, and embodiments of the present invention are contemplated for use with any manner of communication amongst members. The system may be further configured to allow individual users to communicate via the various social networking sites via application programming interfaces (APIs) enabled to provide third-party interaction with said various social networking sites.

According to an embodiment of the present invention, once an individual user has joined and been approved by a campaign, the system is configured to track the various tasks of the individual user to monitor the number of incentivized tasks that are completed. This may include tracking whether a user has posted incentivized content, commented on incentivized content, liked incentivized content or any combination thereof.

According to an embodiment of the present invention, once one or more incentivized tasks have been completed, the system may release funds or other rewards to the individual user's account for use as allowed by the system. For instance, released funds may be utilized to purchase goods or services provided on or by the system. Alternatively, the system may be configured to release funds to the individual user's bank account, PayPal account or other financial account.

According to an embodiment of the present invention, the system may provide one or more verification services designed to verify the identity or certain characteristics (e.g., age, gender, income, name) of the individual user. As noted above, verification services may be provided automatically, manually or any combination thereof.

According to an embodiment of the present invention, the system may be configured to be accessible via one or more remote platforms via one or more devices. For instance, interfaces may be provided for use on one or more social networking platforms (e.g., via APIs) such that users and visitors can take advantage of tasks on various platforms. In this manner, users may be able to access and utilize the benefits of the system described herein on any of their favorite platforms utilizing any of their favorite devices (e.g., smartphone, tablet PC, laptop, desktop).

Exemplary Methods

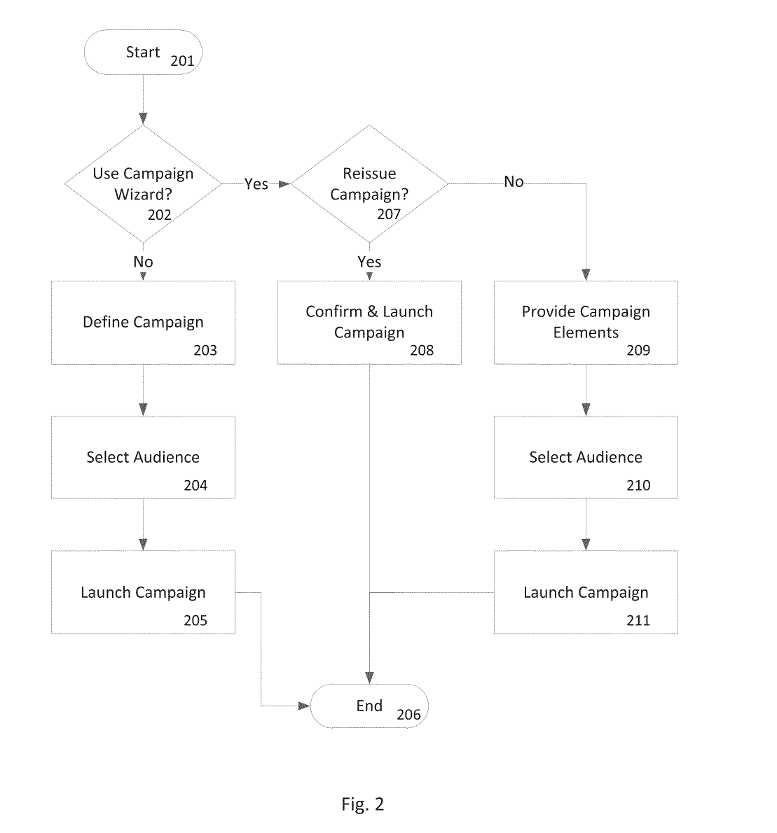

Turning now to FIG. 2, an exemplary process for generating a campaign, in accordance with an embodiment of the present invention, is shown. The process starts at step 201, where the campaign creator has logged into the system and chosen to initiate a new campaign.

At step 202, the campaign creator is offered the opportunity to utilize a campaign creator wizard. As noted previously, campaign wizards provide guidance and ease to the campaign creation process. However, the campaign creator is offered the opportunity to create and design the campaign completely manually if desired. In many cases, creating a campaign manually allows for greater customization, but is a longer and more involved process.

At step 203, the campaign creator has decided to manually configure and design a campaign. In this definition step, the campaign creator selects all of the pertinent criteria for the campaign. Pertinent criteria may include, but is not limited to, the type of task to incentivize, the actual incentive offered and at what levels the incentives are offered. In an exemplary embodiment, the various criteria for selection may be separated onto multiple pages for ease of display and use.

At step 204, the campaign creator selects the audience to be incentivized. The audience includes those who the campaign creator wishes to incentivize to take the incentivized actions and those whom the campaign creator wishes to be affected by said actions. For instance, the campaign creator could make the campaign publicly available for all to participate in for taking one or more incentivized tasks and specify that the particular audience they want to affect is women between the age of 18 and 35.

At step 205, the campaign creator has input all the necessary information required to launch the campaign. Optionally, the system may prompt the user to confirm the information prior to launch. Once confirmed, the system utilizes the given characteristics and parameters to generate a campaign as directed. The system may also be configured to initiate contact with and share the new campaign with those individual users identified by the campaign creator. Where the campaign is identified as public by the campaign creator, the system may be configured to share the campaign with those individual users that have signed up to receive updates regarding publicly available campaigns.

At step 206, the process terminates. The steps are not required to be executed in this order, and one of ordinary skill in the art would appreciate that these steps could be executed in a variety of different manners as well as having two or more of the steps executing simultaneously.

If the campaign creator selected to use a wizard to assist with the launching of a campaign, the process proceeds to step 207, whereby the system requests the campaign creator to identify whether the campaign to be created is a new campaign or a reissue campaign (i.e., a copy of a campaign that has been previously been run or a campaign from a template).

At step 208, the campaign creator has confirmed that the campaign is a reissue campaign and the wizard populates as much or as little of the previous campaign into a new campaign template as the campaign creator desires. Any remaining information will be provided by the campaign creator. At this point, the campaign is prepared for verification and launch. The system then proceeds to step 206 and terminates.

At step 209, The campaign creator has confirmed that the campaign is not a reissue campaign. The wizard then proceeds to provide the campaign creator with one or more screens intended to help the campaign creator identify and select the appropriate elements for the campaign.

At step 210, The wizard assists the campaign creator in selecting the appropriate audience for the campaign, both in terms of who to incentivize and who to target. This can be done, for instance, by providing the campaign creator with one or more questionnaires regarding the goals of the campaign and characteristics of the target audience.

At step 211, the campaign creator has input all the necessary information required to launch the campaign. Optionally, the system may prompt the user to confirm the information prior to launch. Once confirmed, the system utilizes the given characteristics and parameters to generate a campaign as directed. The system may also be configured to initiate contact with and share the new campaign with those individual users identified by the campaign creator. Where the campaign is identified as public by the campaign creator, the system may be configured to share the campaign with those individual users that have signed up to receive updates regarding publicly available campaigns.

At step 206, the process terminates. The steps are not required to be executed in this order, and one of ordinary skill in the art would appreciate that these steps could be executed in a variety of different manners as well as having two or more of the steps executing simultaneously.

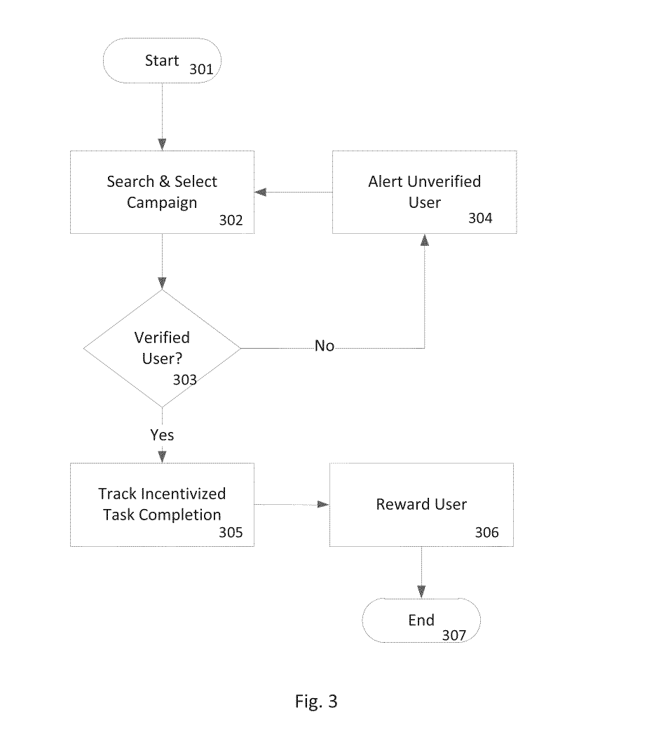

Turning now to FIG. 3, an exemplary process for a user interacting with a campaign, in accordance with an embodiment of the present invention, is shown. The process starts at step 301, where a user has logged into the system and desires to interact with a campaign.

At step 302, the system is configured to provide the user the ability to search for campaigns to participate in. These campaigns may include campaigns the user was invited to by one or more campaign creators. The campaigns may also include campaigns the user searched for by one or more parameters chosen by the user. Parameters may include, but are not limited to, target audience, company involved, product involved and content incentivized.

At step 303, the user has requested to be a part of a campaign. If verification of users was requested during the configuration of the campaign, the user is verified appropriately as discussed above.

At step 304, the system has failed to verify the user as an appropriate user for the particular campaign. At this point, the user may be returned to the campaign selection screen to select another campaign to join.

At step 305, the system has verified the user as an appropriate user for the particular campaign, or the campaign is public and no verification was necessary. At this point, the user may begin to perform the task as required by the campaign. The system is configured to track the tasks completed by the user.

At step 306, the tasks completed by the user are rewarded as defined by the campaign. The rewards may be distributed in a manner as described above. Completed tasks may be instantly rewarded, rewarded on a schedule, rewarded at selected intervals or any combination thereof.

At step 307, the process completes.

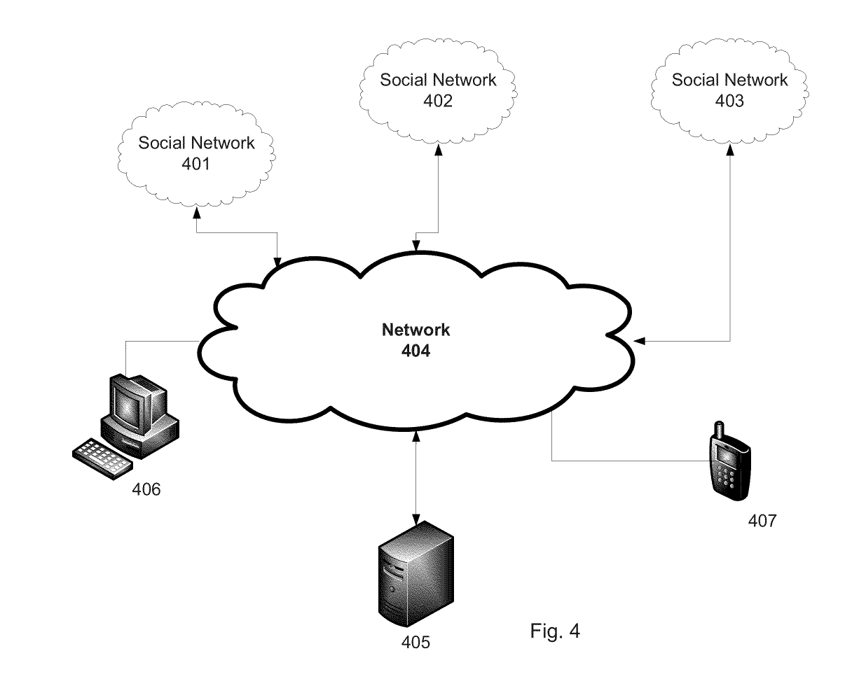

Turning now to FIG. 4, a schematic overview of a network system for aggregating information across social networks, in accordance with an embodiment of the present invention, is shown. In this embodiment, one or more servers 405 of the system are configured to request, receive and aggregate information from a plurality of social networks 401, 402, 403. Once the information has been aggregated, the aggregated information, or any portion thereof, may be provided to users utilizing a computing device (e.g., desktop PC 406, smartphone 407). In this manner, the system may utilize the aggregated information in conjunction with the aforementioned methods of requesting and rewarding social actions taken by various users. The system may be further configured to not only aggregate the information, but provide users the capability of taking social actions at a central location (e.g., Server 405) and have that social action transmitted to one or more social networks 401, 402, 403. While FIG. 4 shows 3 social networks, two user computing devices and one server, one of ordinary skill in the art would appreciate that any number of servers, computing devices and social networks could be utilized in embodiments of the present invention.

Embodiments of the invention also include computer program products for performing various operations disclosed herein. The computer program products comprises program code that may be embodied on a computer-readable or accessible storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. One or more parts of the program code may be distributed as part of an appliance, downloaded, and/or otherwise provided to a customer.

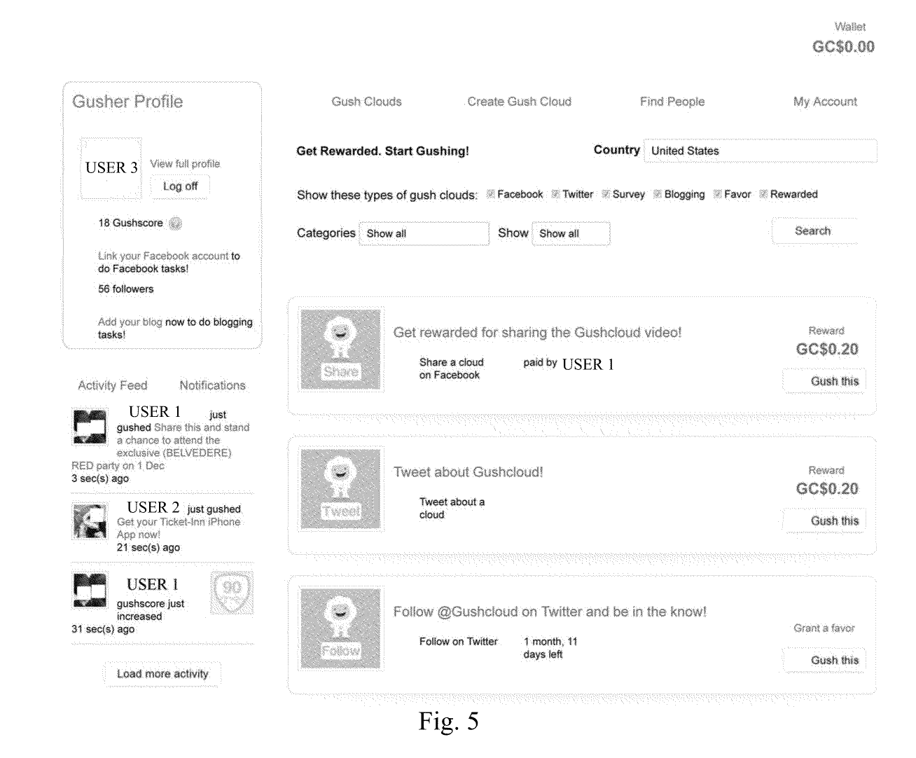

Turning now to FIG. 5, an exemplary dashboard of a content incentivizing platform, in accordance with an embodiment of the present invention, is shown. In this embodiment, a user is displayed a myriad of information related to their campaigns and the campaigns of others. Information provided also included the recent actions of the friends of the user or recent actions of other users of the system.

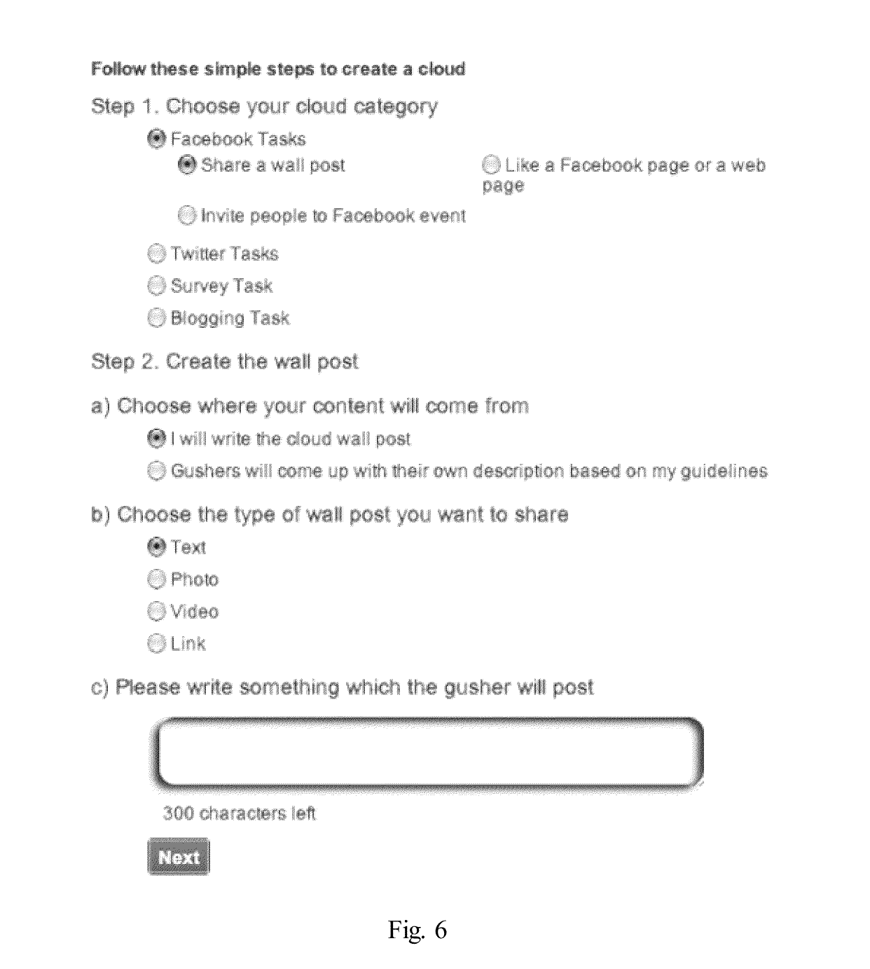

Turning now to FIG. 6, an exemplary wizard screen, in accordance with an embodiment of the present invention, is shown. In this embodiment, a user is presented multiple options to choose from in order to direct the user's creation of a campaign. The multiple options are intended to help direct the user's creation of a campaign that will suit the user's needs. The more inputs received, the more the system may be able to further assist the user in creating a campaign that best suits the user's needs.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method for providing an incentivized campaign process, said method comprising:
presenting, to a user, a first module configured to receive a first input from said user related to a content incentivizing campaign;
receiving, at a server, said first input from said user;
presenting to a user, a second module configured to receive a second input from said user related to an intended audience for said content incentivizing campaign;
receiving at said server, said second input from said user; and
generating a content incentivizing campaign based at least in part on said first input and said second input.

2. The method of claim 1, further comprising the step of providing said content incentivizing campaign to one or more social network users.

3. The method of claim 2, further comprising the step of rewarding one or more participating users from said group of one or more social network users, wherein said one or more participating users accomplished at least one goal.

4. The method of claim 2, further comprising the step of tracking said one or more social network users to verify accomplishment of at least one goal.

5. The method of claim 2, further comprising the step of verifying said one or more social network users.

6. The method of claim 1, wherein said first module is at least partially comprised of a wizard.

7. The method of claim 1, wherein said second module is at least partially comprised of a wizard.

8. The method of claim 1, wherein said second module is further configured to request verification information from said user.

9. A system for providing an automated dispute resolution process, the system comprising:
a first module configured to present one or more screens to a user for requesting information related to a content incentivizing campaign;
a second module configured to present one or more screens to the user for requesting information related to an intended audience of said content incentivizing campaign;
a server configured to receive data from said first module and second module,
wherein said server is configured to generate a content incentivizing campaign from said data received from said first module and second module.

10. The system of claim 9, wherein said server is further configured to provide said content incentivizing campaign to one or more social network users.

11. The system of claim 10, wherein said server is further configured to reward one or more participating users from said group of one or more social network users, wherein said one or more participating users accomplished at least one goal.

12. The system of claim 10, wherein said server is further configured to track said one or more social network users to verify accomplishment of at least one goal.

13. The system of claim 9, wherein said server is further configured to verify said one or more social network users.

14. The system of claim 9, wherein said first module is at least partially comprised of a wizard.

15. The system of claim 9, wherein said second module is at least partially comprised of a wizard.

16. The system of claim 9, wherein said second module is further configured to request verification information from said user.

17. The system of claim 9, wherein said second module is further configured to provide the user the ability to filter the intended audience based on a social influence score.

18. The system of claim 9, wherein said second module is further configured to incentivize the intended audience based on a social influence score.
